(19) United States
(12) Patent Application Publication
(10) Pub. No.: US 2011/0050881 A1
(43) Pub. Date: Mar. 3, 2011

(54) INSPECTION SYSTEM AND METHOD

(75) Inventor: Hajime TERAYOKO, Tokyo (JP)

(73) Assignee: FUJIFILM CORPORATION, Tokyo (JP)

(21) Appl. No.: 12/859,872

(22) Filed: Aug. 20, 2010

(30) Foreign Application Priority Data
Aug. 27, 2009 (JP) JP2009-197148

(51) Int. Cl. H04N 7/18

(52) U.S. Cl. 348/92; 348/E07.085

(57) ABSTRACT

There is provided an accurate association between an inspection result inputted from a mobile terminal and the accurate position and direction on the drawing of a shooting point of an inspection photo shot by a digital camera. In step S21, the PC 3 receives inspection result information sent from the mobile terminal 1 through the communication device 35 and stores the received inspection result information in the storage device 33. In step S22, the PC 3 inputs a set of the inspection photo and the shooting point ID to the storage device 33. In step S23, the processing device 31 of the PC 3 associates the inspection result information and the inspection photo, using the shooting point ID which is contained in the inspection result information stored in the storage device 33 and the shooting point ID which is associated with the inspection photo as keys.

### BACKGROUND OF THE INVENTION

1. Field of the Invention

The present invention relates to a system for supporting a construction inspection work in a construction such as a building construction.

2. Description of the Related Art

Conventionally, there has been developed a system for efficiently performing a construction inspection work in a construction such as a building construction, for example, an inspection called a reinforcement inspection for checking a rebar arrangement state.

Japanese Patent Application Laid-Open No. 2003-288384 discloses a construction photo management system comprising: a digital camera which can easily shoot a construction photo shooting object; and a computer which can easily arrange a plurality of digital photos of the construction photo shooting objects shot by the digital camera as a construction photo album. The construction photo management system further comprises: a mobile information terminal which can easily generate and store explanatory information related to a construction photo shooting object for each construction photo shooting object to be shot by the digital camera; and a photo composition device which displays the explanatory information generated by the mobile information terminal overlapping with a part of the corresponding digital photo.

Japanese Patent Application Laid-Open No. 2005-173698 discloses a construction inspection system comprising: a mobile information terminal in which required inspection information is inputted in a construction until building construction is completed; a digital camera for shooting an inspection place; a computer to which the mobile information terminal and the digital camera are connected and which has an inspection form generating program which fetches inspection information and image data of the inspection place and generates a form; a display device which is connected to the computer; and a printer which is connected as needed to the computer. In the construction inspection system, the form is generated by arranging the image data associated with an inspection item in the inspection information by temporal axis; the signature of an inspector is inputted as image data to a column of the inspector in the inspection item via an input apparatus of the mobile information terminal; and an update password is inputted to the image data of the signature as attribute data.

Japanese Patent Application Laid-Open No. 2006-331260 discloses a system in which a person in charge of shooting uses a mobile terminal for transmitting a site photo with shooting position and direction described later to transmit a photo image with shooting identification information including the photo image, the shooting position, direction, year/month/day, and time information the shooter's name, etc., of a disaster field (including the construction site, travel, observation, etc., to a central server; and then, the server generates an icon for identifying the shooting direction and position, stores the icons separately for each time information, and displays all shooting direction and position identifying icons on a map or a digital aerial photo image in a region of the shooting position.

### SUMMARY OF THE INVENTION

The invention disclosed in Japanese Patent Application Laid-Open No. 2003-288384 is not practical for inspection work in a construction site requiring a large number of shootings because each photo needs to be fetched in the mobile terminal and composited with inspection information. In addition, the invention cannot specify the association between the drawing and the photo in detail such as in which position and direction on the drawing the photo is shot.

The invention disclosed in Japanese Patent Application Laid-Open No. 2005-173698 provides only the time stamp as a key for associating the photo and the inspection information. Therefore, the invention can determine up to “in which shooting point the photo is shot” from the shooting time, but cannot precisely associate up to “in which position or direction the photo is shot” with the inspection information. In addition, the invention does not mention the mechanism for reliably synchronizing the time stamp with the digital camera and the mobile phone.

In practice, an insufficient association between the detailed “shooting point information” such as “in which position or direction of the inspection point the photo is shot” and the photo shot by the digital camera involves a cumbersome arrangement such as associating the inspection result information stored in the mobile terminal with the photo shot by the digital camera after inspection, which does not contribute efficient inspection work.

The invention disclosed in Japanese Patent Application Laid-Open No. 2006-331260 is not intended for inspection and photos are plotted on a map. The position information of a photo is based on GPS, and thus it is difficult to accurately display up to the detailed position in a building. In addition, the mobile phone is based on network communication to and from the central server, but the mobile phone is frequently used in a construction site outside the communication range. Therefore, the invention is not suitable for inspection work in a construction site.

In view of the above, the present invention has been made, and an object of the present invention is to ensure an easy and reliable coordination between a mobile terminal and a digital camera without requiring network communication; to divide an accurate association work between an inspection result inputted from the mobile terminal and the accurate position and direction of the shooting point of an inspection photo on the map and a photo shooting work using the digital camera; and thereby to reduce the burden of photo classification work and to efficiently perform inspection work.

The present invention provides an inspection system comprising:

a mobile terminal having:

an inspection information input unit which accepts an input of inspection information including a map position of an inspection object and an inspection item of the inspection object;

an inspection information display unit which displays the inspection information;

an inspection information input unit which accepts an input of an inspection result associated with the inspection item of the inspection object;

an inspection point specifying unit which accepts a specification of a shooting point indicating a shooting position or direction of the inspection object;

an inspection point identification information transmitting unit which transmits identification information of the specified shooting point; and

an inspection result transmitting unit which transmits inspection result information which is a set of the identification information of the shooting point and the inspection result,

one or more imaging apparatuses having:

an imaging unit which outputs an inspection photo which is image data assuming the inspection object as an object to be shot;

a shooting point identification information receiving unit which receives the identification information of the shooting point; and

an inspection photo transmitting unit which transmits inspection photo information which is a set of the inspection photo and the identification information of the shooting point, and

a receiving unit which receives the inspection result information and the inspection photo information, and

an association processing unit which associates the inspection result and the inspection photo based on the matching between the identification information of the shooting point contained in the inspection result information and the identification information of the shooting point contained in the inspection photo information.

The mobile terminal has a shooting setting information input unit which accepts an input of shooting setting information; and a shooting setting information transmitting unit which transmits the shooting setting information to the plurality of imaging apparatuses. Each of the plurality of imaging apparatuses has a shooting setting information receiving unit which receives the shooting setting information; and a setting unit which sets an imaging condition of the imaging unit based on the shooting setting information.

The imaging unit starts outputting the inspection photo in response to receipt of the identification information of the shooting point from the mobile terminal.

The inspection system includes an information processing apparatus having the association processing unit.

The association processing unit is provided in the mobile terminal.

The present invention provides an inspection method of causing a mobile terminal to execute: a step of accepting an input of inspection information including a map position of an inspection object and an inspection item of the inspection object; a step of displaying the inspection information; a step of accepting an input of an inspection result associated with the inspection item of the inspection object; a step of accepting a specification of a shooting point indicating a shooting position or direction of the inspection object; a step of transmitting identification information of the specified shooting point; and a step of transmitting inspection result information which is a set of the identification information of the shooting point and the inspection result, an imaging apparatus to execute: a step of outputting an inspection photo which is image data assuming the inspection object as an object to be shot; a step of receiving the identification information of the shooting point; and a step of transmitting inspection photo information which is a set of the inspection photo and the identification information of the shooting point, and an information processing apparatus to execute: a step of receiving the inspection result information and the inspection photo information, and a step of associating the inspection result and the inspection photo based on the matching between the identification information of the shooting point contained in the inspection result information and the identification information of the shooting point contained in the inspection photo information.

According to the present invention, an inspection result is inputted to the mobile terminal and an inspection photo is shot by the imaging apparatus in such a manner that the respective operations are performed separately, but the inspection photo and the inspection result can be accurately associated with each other using the identification information of the shooting point as a key.

### BRIEF DESCRIPTION OF THE DRAWINGS

FIG. 1 is a schematic configuration view of a construction inspection system;

FIG. 2 illustrates an internal configuration example of a mobile terminal;

FIG. 3 illustrates an internal configuration example of a digital camera;

FIG. 4 illustrates an internal configuration example of a personal computer;

FIG. 5 is a flowchart of an inspection result input process;

FIG. 6 illustrates a display example of inspection information;

FIG. 7 illustrates a display example of an inspection item;

FIG. 8 is a flowchart of a shooting process;

FIG. 9 is a flowchart of an inspection result associated data storing process; and

FIG. 10 is a flowchart of a shooting setting process.

### DETAILED DESCRIPTION OF THE PREFERRED EMBODIMENTS

### First Embodiment

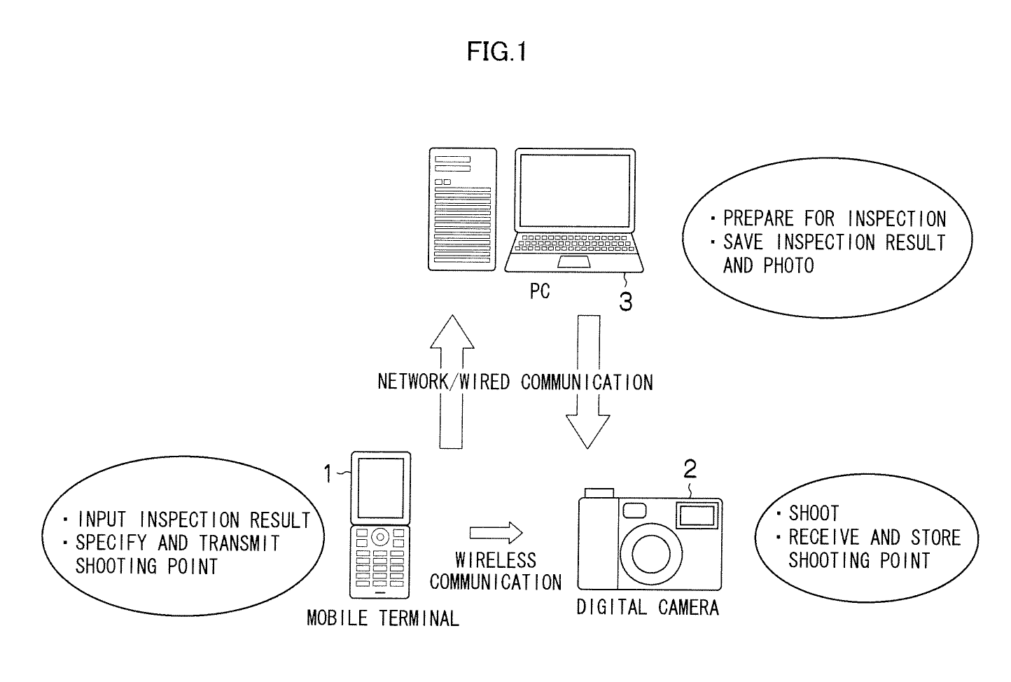

FIG. 1 illustrates a schematic configuration view of a construction inspection system according to a preferred embodiment of the present invention. The inspection system includes a mobile terminal 1, a digital camera 2, and a personal computer (PC) 3. The mobile terminal 1, the digital camera 2, and the PC 3 can be mutually connected to each other through a network such as a mobile communication network, the Internet, and a LAN. FIG. 1 illustrates only one digital camera 2, but a plurality of digital cameras may be used.

The mobile terminal 1 has a function to store inspection data such as a drawing of the construction site, inspection point information, and an inspection item of each inspection point, specify a shooting point of the inspection photo, and input the inspection result while viewing the drawing. The digital camera 2 is an apparatus for shooting an inspection photo. The personal computer 3 is a computer which connects the mobile terminal 1 and the digital camera 2 and manages the life cycle of inspection data. The personal computer 3 may be a client personal computer or may be a server.

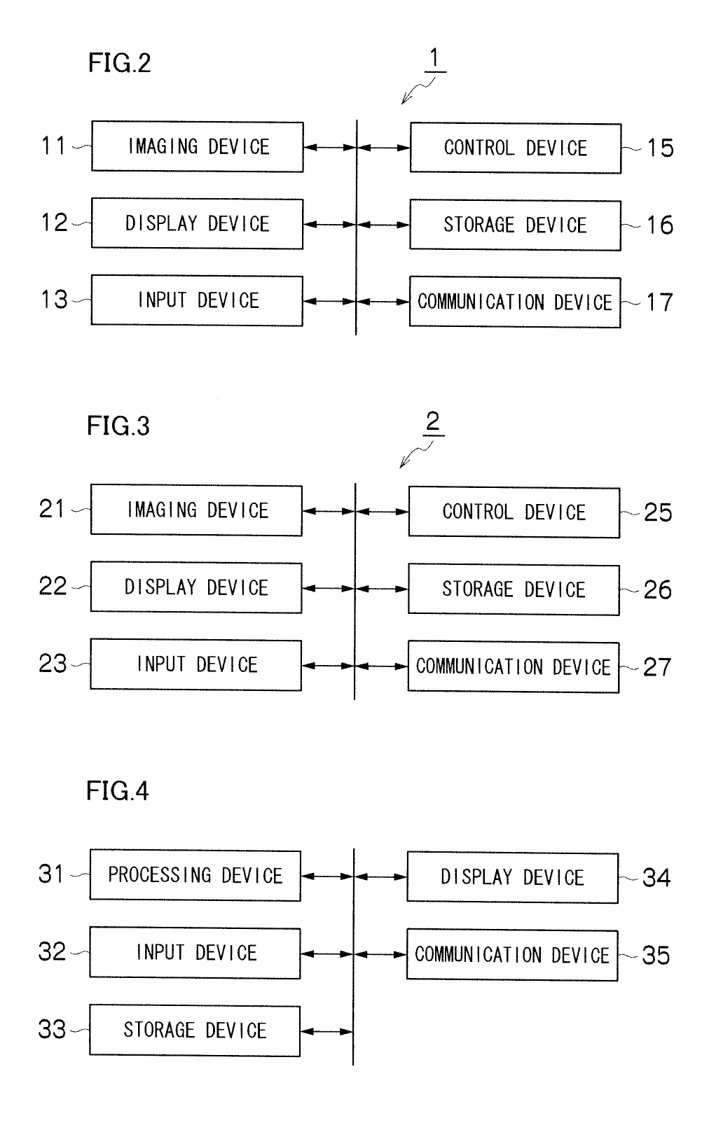

As illustrated in FIG. 2, the mobile terminal 1 includes an imaging device 11 (imaging elements such as a CCD and a CMOS and circuits for converting an image signal from the imaging element to a digital image data), a display device 12 (a liquid crystal display and its driver, etc.), an input device 13 (keys, buttons, switches, a touch panel, etc.), a control device 15 (circuits such as a CPU, a RAM, a ROM, etc., required for a shooting setting process, an inspection process, and a control process), a storage apparatus 16 (a RAM, a ROM, an EEPROM, a SDRAM, a VRAM, a memory card, etc.), a communication device 17 (Ir, Bluetooth, a LAN network adapter, etc.), and the like. Note that the imaging device 11 is not absolutely required for the mobile terminal 1, but the imaging device 11 can shoot an inspection photo instead of the digital camera 2. The mobile terminal 1 can be configured of a well known mobile information terminal such as a mobile phone, a PDA, a mobile personal computer.

When an inspection photo is shot by the digital camera 2, the mobile terminal 1 accepts a specification of inspection point information indicating “in which map position or direction the inspection object is shot” from the input device, and transmits the specified inspection point information to the digital camera 2.

The storage device 16 stores inspection information. The inspection information includes the following information.
Inspection profile information (the site name, the inspection type, the inspection object member, the floor, etc.)
Drawings (the plan view of the entire site, the plan view of an enlarged inspection object vicinity, the framing plan, and other additional drawings)
Inspection point information (coordinates of an inspection point on the drawing, the part numbers of the inspection member) for the number of inspection points
Inspection item information (the inspection point ID and a plurality of inspection items) for the number of inspection points

The drawing allows a markup language such as HTML and XML to be used to specify: first link information which allows the construction object name, the inspection type, the drawing of the inspection place, and the sketch drawing contained in the inspection information to be mutually referred to each other; second link information which allows the member drawing corresponding to each inspection object member and position information of each inspection object member on the sketch drawing contained in the inspection information to be mutually referred to each other; and third link information which allows the position information of each inspection object member and the inspection item (the type, the number, and the pitch of the member) to be mutually referred to each other.

As illustrated in FIG. 3, the digital camera 2 includes an imaging device 21 (imaging elements such as a CCD and a CMOS and circuits for converting an image signal from the imaging element to a digital image data), a display device 22 (a liquid crystal display and its driver, etc.), an input device 23 (keys, buttons, switches, a touch panel, etc.), a control device 25 (circuits such as a CPU, a RAM, a ROM, etc., required for a shooting setting process, an inspection process, and a control process), a storage device 26 (a RAM, a ROM, an EEPROM, a SDRAM, a VRAM, a memory card, etc.), a communication device 27 (Ir, Bluetooth, a LAN network adapter, etc.), and the like. Note that as long as the above configuration is provided, the digital camera 2 may serve as the mobile terminal 1.

As illustrated in FIG. 4, the personal computer 3 includes a processing device 31 (circuits such as a CPU, a RAM, a ROM, etc., required for an arithmetic operation and a control process of each unit), an input device 32 (keys, buttons, switches, a touch panel, etc.), a storage device 33 (a RAM, a ROM, an EEPROM, a SDRAM, a VRAM, memory card, etc.), a display device 34 (a liquid crystal display and its driver, etc.), a communication device 35 (Ir, Bluetooth, a LAN network adapter, etc.), and the like.

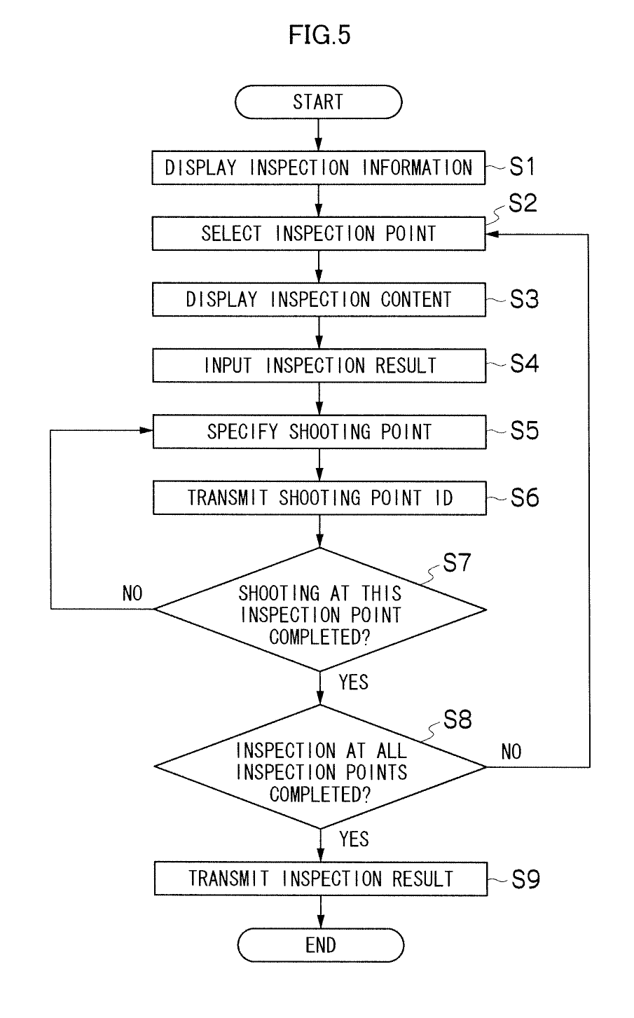

FIG. 5 illustrates a flowchart of an inspection result input process executed by the mobile terminal 1. The programs for causing the mobile terminal 1 to execute this process are stored in the storage device 16 of the mobile terminal 1.

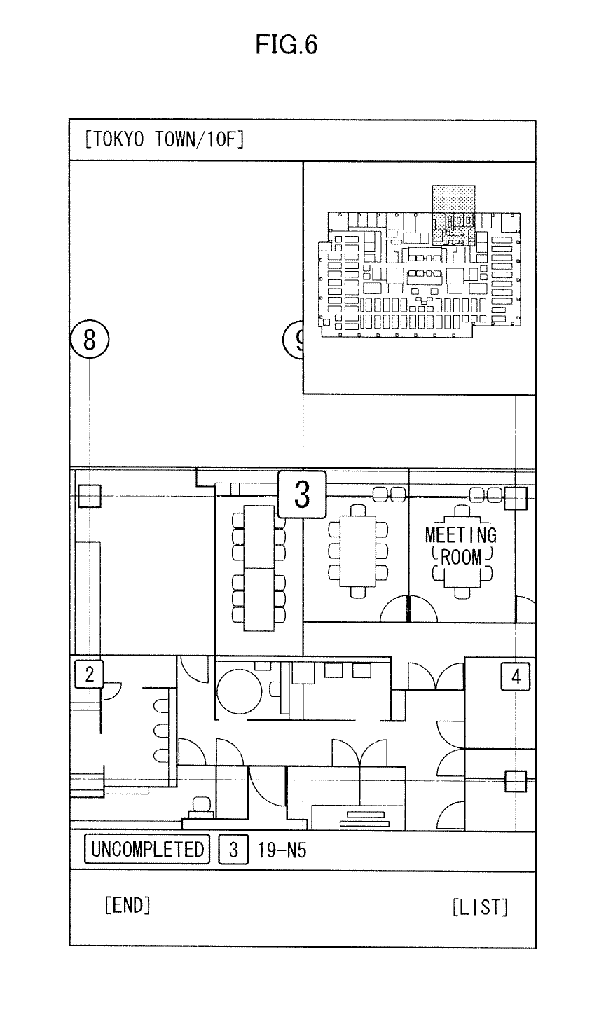

In step S1, the mobile terminal 1 reads inspection information from the storage device 16 and displays the inspection information on the display device 12. FIG. 6 illustrates a display example of the inspection information. In this figure, the display device 12 displays text-based inspection profile information in the upper most portion of the screen, displays a drawing (a plan view of an enlarged inspection object vicinity, of the entire drawing) in the lower portion of the screen, and displays a drawing (entire drawing) in the upper right portion of the screen. On the plan view of the enlarged inspection object vicinity, numbered icons indicating the position of an inspection point on the drawing are superimposed based on the inspection point information. Note that when any place is inspected, the inspection point information may not be specified. In addition, the icon of an inspection point whose inspection is not completed is displayed in the lower portion of the screen based on the inspection result information inputted from the mobile terminal 1. The mobile terminal 1 can generate the numbered icon by its built-in OSD circuit. Note that the inspection information display format is not limited to the format displayed in this figure.

In step S2, the mobile terminal 1 accepts a specification of an inspection point to be subjected to inspection from the inspection point displayed by a numbered icon on the display device 12 through the input device 13. The inspection point specified in this manner is referred to as a fixed-point inspection point. Alternatively, the mobile terminal 1 accepts an operation to specify any position on the drawing of the display device 12 as the inspection point through the input device 13. The inspection point specified in this manner is referred to as any point inspection point. The specification may be inputted in any manner such that a ten key corresponding to the inspection point number is pressed, a pressure is applied to any position of the drawing on the touch panel or to the position in which the numbered icon of the inspection point is displayed, or the cursor moving between the inspection points according to the pressing of the cross-shaped key is set to a desired inspection point and the OK key is pressed. Moreover, the inspection point may be selected in any order, or namely, a plurality of inspection points may be inspected in any sequence.

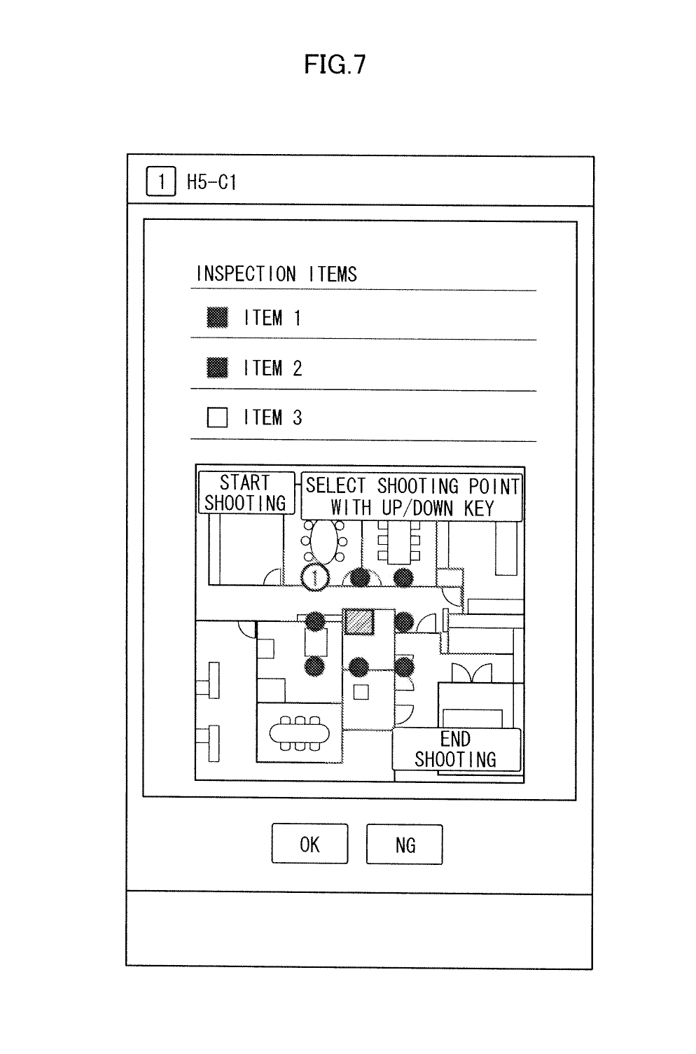

In step S3, the mobile terminal 1 displays the detailed drawing and the inspection items corresponding to the selected inspection point (current inspection point) on the display device 12. FIG. 7 illustrates a display example thereof.

In step S4, the mobile terminal 1 accepts an input of whether the inspection result is OK or not for each inspection item corresponding to the current inspection point through the input device 13. The inspection result may be inputted by any method. In FIG. 7, the mobile terminal 1 accepts an inspection result corresponding to each inspection item by accepting a selection input of the icon “OK” or “NG” by touching or cursor setting for each selected inspection item.

In step S5, the mobile terminal 1 accepts a shooting point specification indicating the position (coordinates on the map) or the direction (direction from the shooting position to the inspection point) in which an inspection photo assuming the current state of the inspection point as the object to be shot is to be shot by the digital camera 2 through the input device 13. The shooting point specification may be inputted in any manner such that a ten key corresponding to the shooting point number is pressed, a pressure is applied to a position in which the shooting point is displayed on the touch panel, or the cursor moving between the shooting points according to the pressing of the cross-shaped key is set to a desired shooting point and the OK key is pressed. Preferably, the color and the shape of the icon of the current shooting point which is an actually specified shooting point are displayed differently from the color and the shape of the icon of the other shooting points.

In FIG. 7, the display device 12 of the mobile terminal 1 displays eight shooting points surrounding the inspection point in eight directions with dots. When the input device 13 accepts the specification of the upper left shooting point of the eight shooting points, the display device 12 displays the shooting point number “1” superimposed on the drawing.

In step S6, the mobile terminal 1 transmits the shooting point ID which is information uniquely identifying the current shooting point to the digital camera 2 through the communication device 17. The communication device 17 may adopt any communication system, but in consideration of the possibility that the construction site is outside the area of the mobile communication network, a near field communication such as an infrared communication and Bluetooth or a wired communication such as a USB are considered to be effective. The mobile terminal 1 stores the shooting point ID and the shooting point information (the inspection point on the drawing and the position coordinates and the shooting direction of the inspection point) which have been transmitted, in the storage device 16.

In step S7, the mobile terminal 1 accepts the specification of whether the inspection photo shooting at the current inspection point is to be finished or not through the input device 13. If an inspector specifies a plurality of different shooting points at the same inspection point to shoot a plurality of inspection photos, the inspector may specify “NO”. When “Yes” is specified, the process of the mobile terminal 1 moves to step S8. When “NO” is specified, the process of the mobile terminal 1 returns to step S5 and repeats the processes S5 to S6 for each inspection photo shooting. Thus, even if a plurality of current shooting points corresponding to the same inspection point is specified, the mobile terminal 1 transmits a shooting point ID corresponding to a current shooting point one by one each time the current shooting point is specified.

In step S8, the mobile terminal 1 accepts the specification of whether the inspection photo shooting at all shooting points is to be finished or not through the input device 13. When “Yes” is specified, the process of the mobile terminal 1 moves to step S9. When “NO” is specified, the process of the mobile terminal 1 returns to step S2.

In step S9, the mobile terminal 1 transmits inspection result information to the PC 3. The inspection result information includes the following content.
Inspection profile information (site name, inspection type, inspection object member, floor, etc.)
Inspection implementation information (the inspection implementation year/month/day, inspection start time, the inspection end time, and the inspector name)
Drawings (the plan view of the entire site, the plan view of an enlarged inspection object vicinity, the framing plan, and other additional drawings)
Inspection point information (the coordinates on the drawing, the part number of the inspection member) for the number of inspection points
Inspection results corresponding to an inspection item (a set of the inspection point ID, the inspection item, the failure type, the error condition, the member type, and the inspection result corresponding to the inspection item) for the number of inspection points
Shooting point information (the shooting point ID, the coordinate on the drawing, the direction, and shooting point information for the number of associations) for the number of inspection points

Note that the mobile terminal 1 may transmit the inspection result information to the personal computer 3 at any timing. For example, when the mobile terminal 1 enters a communication area of the mobile communication network, the mobile terminal 1 may transmit the inspection result information or as long as the mobile terminal 1 is located inside a communication area, each time an inspection is finished, the mobile terminal 1 may transmit the inspection result information.

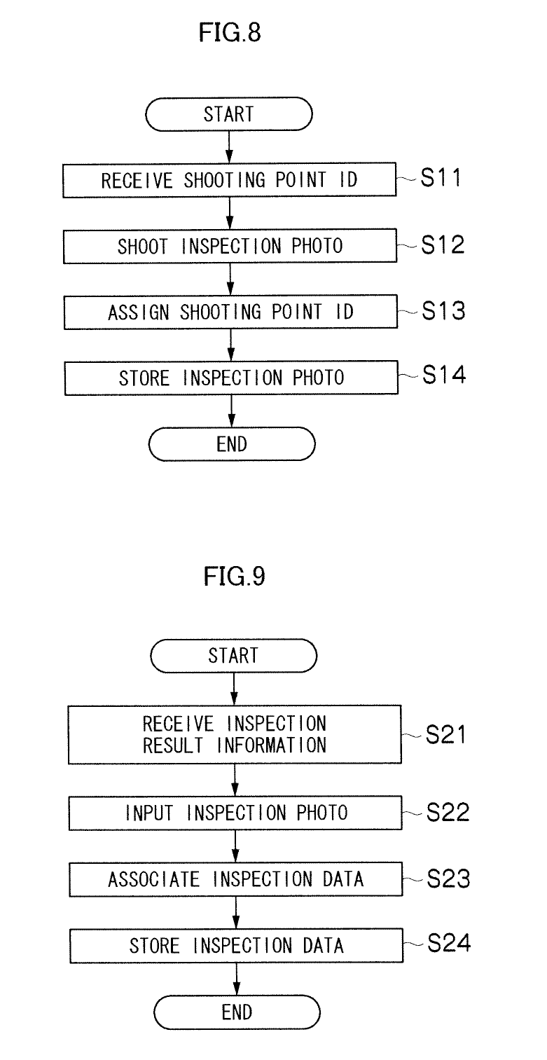

FIG. 8 illustrates a flowchart of the shooting process of causing the digital camera 2 to execute. The programs for causing the digital camera 2 to execute this process are stored in the storage device 26 of the digital camera 2. If a plurality of digital cameras 2 are used, each of the digital cameras 2 independently executes the following process.

In step S11, the digital camera 2 receives a shooting point ID sent from the mobile terminal 1 through the communication device 27. The digital camera 2 stores the received shooting point ID in a RAM of the storage device 26.

In step S12, the digital camera 2 controls the imaging device 21 in response to the input of a shooting instruction from the input device 23 and acquires the inspection photo which is image data assuming the inspection object as an object to be shot. Alternatively, the digital camera 2 can control the imaging device 21 in response to the receipt of the shooting point ID and can acquire the inspection photo which is image data assuming the inspection object as an object to be shot. Moreover, it may be selected from the input device 23 that in which trigger of the input of the shooting instruction or the receipt of the shooting point ID, the inspection photo is acquired.

In step S13, the control device 25 of the digital camera 2 associates the image data of the inspection photo with the shooting point ID stored in the RAM. The data may be associated in any manner. For example, the shooting point ID is written as additional information to the header, tag, or metadata of an image file which compresses and records the image data of the inspection photo. The image file may be compressed in any format and the tag may be recorded in any format. Typically, the image file may be compressed in JPEG format and the tag may be recorded in Exif format. Alternatively, the image data of the inspection photo and the shooting point ID are packaged separately in a different file and each file may be linked by a markup language such as XML or a relational table.

In step S14, the control device 25 of the digital camera 2 stores a set of the image data of the inspection photo and the shooting point ID associated in step S13 in the storage device 26. Note that the mobile terminal 1 transmits the shooting points ID one by one, and thus the digital camera 2 executes the processes S11 to S14 each time one shooting point ID is received.

FIG. 9 illustrates a flowchart of the inspection result associated data storing process executed by the PC 3. The programs for causing the digital camera 2 to execute this process are stored in the storage device 33 of the PC 3.

In step S21, the PC 3 receives inspection result information sent from the mobile terminal 1 through the communication device 35 and stores the received inspection result information in the storage device 33. The mobile terminal 1 and the PC 3 may use any communication system, but the mobile terminal 1 is located in the construction site. Therefore, the mobile terminal 1 is not always in the communication range of the mobile communication network. As long as the mobile terminal 1 is located in the communication range of the mobile communication network, the PC 3 can receive the inspection result information each time the mobile terminal 1 transmits the inspection result information.

In step S22, the PC 3 inputs a set of the inspection photo and the shooting point ID to the storage device 33. The inspection photo may be inputted to the PC 3 in any route. For example, when the digital camera 2 records the set of the inspection photo and the shooting point ID in a memory card, the PC 3 reads the image file of the inspection photo having the shooting point ID as the additional information from the memory card inserted into a memory card slot of the PC 3 and inputs the image file to the storage device 33. Alternatively, a USB cable is connected between the USB ports of the PC 3 and the digital camera 2, and the set of the inspection photo and the shooting point ID stored in the digital camera 2 is transmitted to the PC 3 through USB communication. Alternatively, the PC 3 and the digital camera 2 are connected by infrared communication or a wireless network such as Bluetooth, and the set of the inspection photo and the shooting point ID stored in the digital camera 2 is transmitted to the PC 3. The PC 3 can communicate with the digital camera 2 in any route. When the PC 3 is connected to the digital camera 2, the inspection photos may be transmitted collectively from the digital camera 2 to the PC 3. Alternatively, each time the digital camera 2 shoots an inspection photo, the digital camera 2 may transmit the inspection photo to the PC 3. When a plurality of digital cameras 2 are used, the PC 3 inputs each set of the inspection photo and the shooting point ID sent from each of the digital cameras 2 to the storage device 33.

In step S23, the processing device 31 of the PC 3 associates the inspection result information and the inspection photo, using the shooting point ID which is contained in the inspection result information stored in the storage device 33 and the shooting point ID which is associated with the inspection photo as keys. That is, the processing device 31 extracts an inspection photo having a shooting point ID matching the shooting point ID contained in the inspection result information from the storage device 33 and associates the inspection result information and the inspection photo for each of the same shooting point ID. The association may be performed in any manner. For example, a markup language may be used to code the correspondence between the inspection result information, and the inspection photo or a relational table may be used to code the correspondence between the inspection result information and the inspection photo. If a plurality of inspection photos is shot at the same shooting point, the same shooting point ID is associated with the inspection photos.

In step S24, the processing device 31 of the PC 3 stores the set of the inspection result information and the inspection photo associated in step S23 again as inspection result associated data in the storage device 33. The inspection result associated data may be stored in any manner. For example, the processing device 31 classifies the inspection result associated data based on a predetermined rule such as the inspection place or inspection date and stores the data in a dedicated database provided in the storage device 33. Alternatively, the processing device 31 classifies and stores the inspection result associated data in a folder provided based on a predetermined classification rule. The processing device 31 may store data specifying the association of the storage destinations between the inspection result information and the inspection photo (for example, the path to the storage destination folder of the shooting point ID and the inspection photo) in the storage device 33.

After the above processing, the PC 3 can associate the set of the inspection result and the inspection photo and can output to the display device 34, an external storage medium, a communication terminal, a printer, and the like.

Note that the above process can be executed not by the PC 3, but by the mobile terminal 1. Further, the association of the inspection result information and the inspection photo using the shooting point ID as the key is not necessarily performed by the PC 3, but may be performed by an information processing device (having a well-known arithmetic device such as a CPU, a RAM, a ROM, and an I/O) or any electronic device having the information processing device.

### Second Embodiment

In the construction inspection system according to the first embodiment, when a plurality of digital cameras 2 are used and a plurality of working members forms a team, each member of which uses a digital camera 2 to shoot an inspection photo at a different shooting point of the same inspection point, it is preferable that the shooting setting of the plurality of digital cameras 2 is performed from the mobile terminal 1, and inspection photos are shot under the unified shooting setting for the plurality of digital cameras 2.

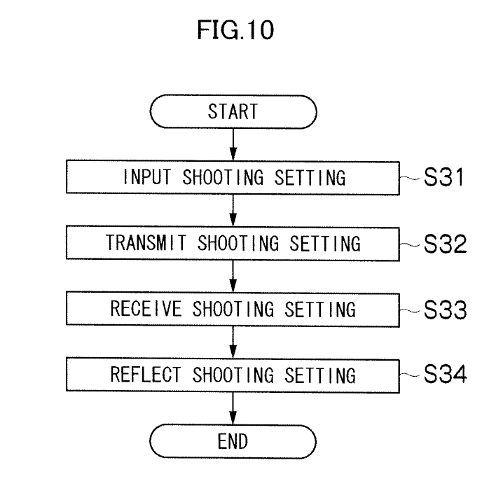

FIG. 10 illustrates a flowchart of a shooting setting process executed by the mobile terminal 1 and the digital camera 2.

In step S31, the mobile terminal 1 accepts an input of desired shooting setting information to be set to the digital camera 2 through the input device 13. The shooting setting information is information for specifying the operating conditions of the imaging device 21 related to the inspection photo shooting such as a shooting date information acquiring source (a real-time clock built in the mobile phone 1, a GPS satellite, etc.), a photo resolution (for example, 800×600 pixels), a shooting mode (for example, a normal mode, a night view mode, a person mode, a forced flush mode, etc.), a flush ON/OFF, a white balance, and the like. The shooting setting information may include common information (such as the illumination of the site) specific to the inspection point and other information.

In step S32, the mobile terminal 1 transmits the inputted shooting setting information to all digital cameras 2. The transmission may be made in any route.

In step S33, each of the digital cameras 2 receives the shooting setting information transmitted from the mobile terminal 1.

In step S34, each of the digital cameras 2 sets the shooting conditions for the imaging device 21 (the imaging device 11 of the mobile phone 1 if the digital camera 2 serves as the mobile terminal 1) based on the received shooting setting information. The settings may be performed by any method. The shooting setting information setting function originally provided in the digital camera 2 may be used.

As described above, the shooting setting information set by the mobile phone 1 can be uniformly reflected on the plurality of digital cameras 2, thus allowing each different digital camera 2 to shoot an inspection photo at the same inspection point under the equal conditions. Moreover, after inspection, all inspection photos shot by each digital camera 2 under the equal conditions are inputted together with the shooting point IDs to the personal computer 3, and the inspection photo and the inspection result information are accurately associated with each other using the shooting point ID as the key.

What is claimed is:

1. An inspection system comprising:
a mobile terminal having:
an inspection information input unit which accepts an input of inspection information including a map position of an inspection object and an inspection item of the inspection object;
an inspection information display unit which displays the inspection information;
an inspection information input unit which accepts an input of an inspection result associated with the inspection item of the inspection object;
an inspection point specifying unit which accepts a specification of a shooting point indicating a shooting position or direction of the inspection object;
an inspection point identification information transmitting unit which transmits identification information of the specified shooting point; and
an inspection result transmitting unit which transmits inspection result information which is a set of the identification information of the shooting point and the inspection result,
one or more imaging apparatuses having:
an imaging unit which outputs an inspection photo which is image data assuming the inspection object as an object to be shot;
a shooting point identification information receiving unit which receives the identification information of the shooting point; and
an inspection photo transmitting unit which transmits inspection photo information which is a set of the inspection photo and the identification information of the shooting point,
a receiving unit which receives the inspection result information and the inspection photo information, and
an association processing unit which associates the inspection result and the inspection photo based on the matching between the identification information of the shooting point contained in the inspection result information and the identification information of the shooting point contained in the inspection photo information.

2. The inspection system according to claim 1, wherein
the mobile terminal has:
a shooting setting information input unit which accepts an input of shooting setting information; and
a shooting setting information transmitting unit which transmits the shooting setting information to the plurality of imaging apparatuses,
each of the plurality of imaging apparatuses has:
a shooting setting information receiving unit which receives the shooting setting information; and
a setting unit which sets an imaging condition of the imaging unit based on the shooting setting information.

3. The inspection system according to claim 1, wherein the imaging unit starts outputting the inspection photo in response to receipt of the identification information of the shooting point from the mobile terminal.

4. The inspection system according to claim 2, wherein the imaging unit starts outputting the inspection photo in response to receipt of the identification information of the shooting point from the mobile terminal.

5. The inspection system according to claim 1, further comprising an information processing apparatus having the association processing unit.

6. The inspection system according to claim 2, further comprising an information processing apparatus having the association processing unit.

7. The inspection system according to claim 3, further comprising an information processing apparatus having the association processing unit.

8. The inspection system according to claim 4, further comprising an information processing apparatus having the association processing unit.

9. The inspection system according to claim 1, wherein the association processing unit is provided in the mobile terminal.

10. The inspection system according to claim 2, wherein the association processing unit is provided in the mobile terminal.

11. The inspection system according to claim 3, wherein the association processing unit is provided in the mobile terminal.

12. The inspection system according to claim 4, wherein the association processing unit is provided in the mobile terminal.

13. An inspection method of causing:
a mobile terminal to execute:
a step of accepting an input of inspection information including a map position of an inspection object and an inspection item of the inspection object;
a step of displaying the inspection information;
a step of accepting an input of an inspection result associated with the inspection item of the inspection object;
a step of accepting a specification of a shooting point indicating a shooting position or direction of the inspection object;
a step of transmitting identification information of the specified shooting point; and
a step of transmitting inspection result information which is a set of the identification information of the shooting point and the inspection result,
an imaging apparatus to execute:
a step of outputting an inspection photo which is image data assuming the inspection object as an object to be shot;
a step of receiving the identification information of the shooting point; and
a step of transmitting inspection photo information which is a set of the inspection photo and the identification information of the shooting point, and
an information processing apparatus to execute:
a step of receiving the inspection result information and the inspection photo information, and
a step of associating the inspection result and the inspection photo based on the matching between the identification information of the shooting point contained in the inspection result information and the identification information of the shooting point contained in the inspection photo information.
